(19) United States
(12) Patent Application Publication
(10) Pub. No.: US 2009/0220814 A1
(43) Pub. Date: Sep. 3, 2009

(54) METAL MATRIX COMPOSITE MATERIAL

(76) Inventors: Toshimasa Nishiyama, Niigara-shi (JP); Takutoshi Kondou, Niigata-shi (JP); Hideki Ishii, Shizuoka-shi (JP); Kazuto Sanada, Shizuoka-shi (JP); Toshiaki Yamazaki, Kawasaki-shi (JP)

Correspondence Address: SMITH PATENT OFFICE, 1901 PENNSYLVANIA AVENUE N W, SUITE 901, WASHINGTON, DC, 20006, US

(21) Appl. No.: 12/428,244

(22) Filed: Apr. 22, 2009

Related U.S. Application Data
(63) Continuation-in-part of application No. 11/976,329, filed on Oct. 23, 2007.
Application No. 11/976,329 is a continuation-in-part of application No. 11/976,330, filed on Oct. 23, 2007.
Application No. 11/976,330 is a continuation-in-part of application No. 11/976,331, filed on Oct. 23, 2007.

(51) Int. Cl. B32B 15/04; B22F 7/04

(52) U.S. Cl. 428/554; 419/8

(57) ABSTRACT

A metal matrix composite material comprising a pair of metal plates having a powder mixture disposed therebetween forming an intermediate layer is disclosed. The powder mixture includes a metal powder and a ceramic powder. The ceramic powder has a neutron absorbing function and includes a B₄C powder. The intermediate layer has a theoretical density ratio at least 98%, and a percentage of a total thickness of the metal plates to an overall thickness of the intermediate layer is in a range of 15 to 25% and the ceramic powder has a neutron absorption rate of at least 90%.

### CROSS-REFERENCE TO RELATED APPLICATIONS

This application is a continuation-in-part application based on U.S. patent application Ser. Nos. 11/976,329; 11/976,330 and 11/976,331 all filed on Oct. 23, 2007. The subject matter of these applications is incorporated herein by reference.

### BACKGROUND OF THE INVENTION

1. Field of the Invention

The present invention generally relates to a metal matrix composite material having a neutron absorption capability, and more specifically, to a metal matrix composite material having excellent properties, such as plastic workability, thermal conductivity, room-temperature or high-temperature strength, high stiffness, wear resistance and low thermal expansibility.

2. Description of the Related Art

Heretofore, there has been known a method of producing a composite material having an aluminum matrix through a powder metallurgy process, comprising the steps of:

(1) mixing a powder of a ceramic material serving as a reinforcing material, such as Al₂O₃, SiC, B₄C, BN, aluminum nitride or silicon nitride, with an aluminum powder serving as a matrix;

(2) subjecting the powder mixture to canning or cold compaction to form a compact;

(3) subjecting the compact to degassing, sintering, etc.; and

(4) forming the sintered compact into a desired shape.

The sintering process in the step (3) includes: a technique (A) of simply heating the compact; a technique (B) of pressing the compact at high temperatures, such as hot pressing; a technique (C) of sintering the compact through hot plastic working, such as hot extruding, hot forging or hot rolling; a technique (D) of pressing the compact while applying a pulse current thereto, i.e., subjecting the compact to so-called “pulse-current pressure sintering” (as disclosed, for example, in JP Patent Application Publication No. 2001-329302A); and a technique (E) based on a combination of two or more of the techniques (A) to (D). There has also been known a technique of performing the sintering process in conjunction with the degassing process.

In recent years, aluminum matrix composite materials have been increasingly developed for use in new applications requiring not only strength but also a high Young's modulus, wear resistance, low thermal expansibility and neutron absorption capability. Although a neutron absorbing function can be enhanced by increasing an amount of a ceramic powder having a neutron absorbing function, an approach of simply increasing an amount of the ceramic powder will cause significant deterioration in sinterability and plastic workability, such as, extrudability, rollability or forgeability.

From this standpoint, there has been proposed a technique of preparing a ceramic preform, and impregnating the ceramic preform with molten aluminum alloy to allow ceramic particles to be uniformly dispersed over an aluminum alloy matrix in a high density. In reality, this technique is likely to involve problems about insufficiency of the impregnation with the molten aluminum alloy, and occurrence of defects, such as shrinkage during solidification of the molten aluminum alloy.

International Publication No. WO 2006/070879 discloses a production method for an aluminum matrix composite material, which is intended to solve the above problem, wherein the method comprises the steps of: (a) mixing an aluminum powder and a ceramic powder to prepare a powder mixture; (b) subjecting the powder mixture to pulse-current pressure sintering together with a metal sheet to form a cladded material where a sintered compact is clad with the metal sheet; and (c) subjecting the cladded material to plastic working to obtain an aluminum matrix composite material.

In WO 2006/070879, before the powder mixture prepared by mixing an aluminum powder and a ceramic powder is subjected to a rolling process, it is necessary to subject the powder mixture to pulse-current pressure sintering, while being sandwiched between metal sheets, so as to form a cladded material having the powder mixture preformed in such a manner as to be maintained in a given shape. The reason is that it is difficult or substantially impossible to roll the cladded material unless the powder mixture is preformed in such a manner as to be maintained in a given shape by sintering.

As above, in WO 2006/070879, it is essential to preform the cladded material in such a manner as to be maintained in a given shape, i.e., to subject the powder mixture to pulse-current pressure sintering, which leads to deterioration in process efficiency and difficulty in achieving an intended cost reduction. Thus, there remains a strong need for solving these problems.

U.S. Pat. No. 5,965,829 (Haynes et al.) discloses a structural feature of a neutron absorbing material which pertains to an intermediate layer of a cladded material. However the Haynes patent does not relate to a cladded material as in the present invention. In the Haynes patent, the neutron absorbing material is produced by mixing a B₄C powder as a ceramic powder with an aluminum powder, sintering the obtained powder mixture and rolling the obtained sintered body.

In the Haynes patent, the powder mixture is prepared by simply mixing the B₄C powder with the aluminum powder. Thus, the density of a preform obtained by the sintering is no more than of the powder mixture obtained by simply mixing the B₄C powder with the aluminum powder, and thereby the preform is in a “loose” state in terms of density, specifically has a bulk density of only about 90%. Even if the powder mixture having such a loose density is preformed by a sintering process and then the preform is subjected to an extruding process, an intermediate layer of a resulting extruded product comprising the aluminum powder and the B₄C powder will have a density of about 95% at the highest. Thus, this product has poor thermal conductivity, and has problems because of its mechanical characteristics, such as tensile strength and bending strength.

### SUMMARY OF THE INVENTION

In view of the above circumstances, it is a primary object of the present invention to provide a high-quality metal matrix composite material capable of sufficiently meeting market requirements for both neutron absorption characteristics and tensile strength.

It is another object of the present invention to provide a metal matrix composite material capable of sufficiently meeting market requirements for both neutron absorption characteristics and 0.2% proof stress.

It is yet another object of the present invention to provide a metal matrix composite material capable of sufficiently meeting market requirements for both neutron absorption characteristics and thermal conductivity.

As used in this specification and the appended claims, the term “aluminum” means both pure aluminum and an aluminum alloy.

In one preferred embodiment of the present invention, the metal matrix composite material is produced by mixing a metal powder and a ceramic powder having a neutron absorbing function to prepare a powder mixture, packing the powder mixture into a hollow flat-shaped metal casing while increase a packing density of the powder mixture by means of tapping (one type of vibration), hermetically closing the metal casing to prepare a pre-rolling assembly, preheating the pre-rolling assembly, and rolling the preheated assembly.

In this embodiment, the pre-rolling assembly is formed by packing the powder mixture into the metal casing while increasing a packing density of the powder mixture by means of tapping, and hermetically closing the metal casing. Specifically, the pre-rolling assembly is formed in such a manner that the powder mixture, i.e., mixed fine particles, is sandwiched from above and below by two metal plates serving as top and bottom walls of the metal casing. Thus, after preheating, the pre-rolling assembly can be subjected to rolling to reliably form a cladded material in which a layer of the mixture of the metal powder and the ceramic powder is cladded from above and below by the metal plates while being maintained in a high packing density.

In the above embodiment, a top surface of a powder mixture corresponding to an intermediate layer of the metal matrix composite material with a cladded structure is in close contact with a top wall of an upper casing corresponding to an upper layer in the cladded structure, and a bottom surface of the powder mixture corresponding to the intermediate layer in the cladded structure is in close contact with a bottom wall of a lower casing corresponding to a lower layer in the cladded structure. Thus, in the metal matrix composite material obtained by rolling such a pre-rolling assembly, the adjacent layers are tightly bonded together, and thereby mechanical strength of the metal matrix composite material is drastically increased.

In another preferred embodiment of the present invention, the metal powder is a powder of pure aluminum having a purity of 99.0% or more, or a powder of aluminum alloy comprising Al and 0.2 to 2 weight % of at least one selected from the group consisting of Mg, Si, Mn and Cr, wherein the ceramic powder is contained in an amount of 0.5 to 60 mass % with respect to 100 mass % of the powder mixture.

Generally, a ceramic powder, such as a B₄C powder, to be added as a material having a neutron absorption function, has extremely high hardness as compared with a metal powder. Thus, if a metal powder containing a large amount of ceramic powder is sintered to form a sintered body and the sintered body is subjected to plastic working, in a conventional manner, ceramic particles in a surface of the sintered body are highly likely to trigger fracture, resulting in occurrence of cracking in a plastic-worked product. Such ceramic particles also cause a problem about wear of an extrusion die, a mill roll, a forging die, etc.

In the present invention, the metal matrix composite material is produced without any sintering process, such as pulse-current pressure sintering. Thus, a surface of the metal matrix composite material is free from ceramic particles which trigger fracture and cause wear of a rolling die or the like. This uniquely provides an advantage of being able to obtain a high-quality rolled product, as a first feature of the present invention.

Further, in a process of cladding the powder mixture from above and below by metal plates, top and bottom walls of the hollow casing can serve as the upper and lower metal plates for forming a cladded material. Thus, a structure of a cladded material is obtained only by packing the powder mixture into the casing. This process facilitates simplifying the production process.

In a conventional method, a density of the powder mixture is increased to a value high enough to allow the powder mixture to be maintained in a predetermined shape required for rolling. For example, it is necessary to increase a bulk density of the powder mixture up to 98% or more. In the present invention, the powder mixture is directly subjected to rolling, in powder form. Thus, a bulk density to be maintained in a state after the powder mixture is packed in the casing, is enough to be about 65% at a maximum.

These and other objects, features, and advantages of the present invention will become apparent upon reading the following detailed description along with the accompanying drawings.

### BRIEF DESCRIPTION OF THE DRAWINGS

FIG. 1 is a perspective view showing a structure of a metal casing for use in a production method for a metal matrix composite material according to an embodiment of the present invention.

FIG. 2A is an explanatory diagram showing a structure of a reinforcing frame for use in the production method.

FIG. 2B is a vertical sectional view showing the metal casing after a powder mixture is packed therein.

FIGS. 3A to 3H are explanatory diagrams showing a process of tapping to be performed in the production method.

FIG. 4 is a graph showing a correlative relationship between a ¹⁰B areal density and a neutron penetration rate in the metal matrix composite material according to the embodiment.

FIGS. 5A to 5C are scanning electron microscopic (SEM) photographs (magnification: 750×) showing a surface of a powder mixture before the tapping at different positions.

FIGS. 6A to 6C are SEM photographs (magnification: 750×) showing a surface of the powder mixture after the tapping at different positions.

FIG. 7 is a microscopic photograph (magnification: 100×) showing a region around an upper skin layer of a cladded material as an end product (metal matrix composite material) obtained by the production method.

FIG. 8 is a microscopic photograph (magnification: 400×) showing the region around the upper skin layer in FIG. 7.

FIG. 9 is a microscopic photograph (magnification: 100×) showing a region around an intermediate layer of the cladded material in FIG. 7.

FIG. 10 is a microscopic photograph (magnification: 400×) showing the region around the intermediate layer in FIG. 9.

FIG. 11 is a graph showing a correlative relationship between respective ones of a ¹⁰B areal density, a tensile strength and a neutron absorption rate in the metal matrix composite material according to the embodiment.

### DETAILED DESCRIPTION OF THE PREFERRED EMBODIMENTS

A metal matrix composite material according to one aspect of the present invention comprises a pair of metal plates having a powder mixture disposed therebetween, the powder mixture including a metal powder, and a ceramic powder having a neutron absorbing function, wherein the ceramic powder includes a B₄C powder, and wherein a ¹⁰B areal density which is an areal density of boron-10 contained in the B₄C powder, is set at 40 mg/cm² or more, whereby the neutron absorbing material can achieve a neutron absorption rate of 90% or more based on the B₄C powder.

According to the other aspect of the present invention comprises an intermediate layer including a metal powder, and a ceramic powder having a neutron absorbing function; a first skin layer made of a metal material and formed on one of opposite surfaces of the intermediate layer in close contact relation therewith; and a second skin layer made of a metal material and formed on the other surface of the intermediate layer in close contact relation therewith, wherein the ceramic powder includes a B₄C powder, and wherein a ¹⁰B areal density which is an areal density of boron-10 contained in the B₄C powder, is set at 40 mg/cm² or more, whereby the neutron absorbing material can achieve a neutron absorption rate of 90% or more based on the B₄C powder.

### First Embodiment

The following description will be made about raw materials for a metal matrix composite material according to an embodiment of the present invention, a production method for the metal matrix composite material, and a specific example of the metal matrix composite material, in this order.

(1) Raw Materials

Aluminum Powder Serving as the Matrix

In a metal matrix composite material according to a preferred embodiment of the present invention, an aluminum powder serving as a matrix is made of an Al based alloy, specifically an aluminum alloy defined as A 1100 by JIS (or AA 1100 by A.A.). More specifically, the aluminum powder comprises 0.25 weight % or less of silicon (Si), 0.40 weight % or less of iron (Fe), 0.05 weight % or less of copper (Cu), 0.05 weight % or less of manganese (Mn), 0.05 weight % or less of magnesium (Mg), 0.05 weight % or less of chromium (Cr), 0.05 weight % or less of zinc (Zn), 0.05 weight % or less of vanadium (V) and 0.03 weight % or less of titanium (Ti), with the remainder being aluminum (Al) and inevitable impurities.

The aluminum powder in the present invention is not limited to the above specific composition. For example, pure aluminum (e.g., JIS 1050 or 1070) and various types of aluminum alloys, such as an Al—Cu based alloy (e.g., JIS 2017), an Al—Mg—Si based alloy (e.g., JIS 6061), an Al—Zn—Mg based alloy (e.g., JIS 7075) and an Al—Mn based alloy, may be used for the aluminum powder, independently or in the form of a combination of two or more of them.

That is, the composition of the aluminum powder may be selectively determined in consideration of the desired characteristics or properties, resistance to deformation during subsequent forming/rolling processes, an amount of ceramic powder to be mixed therewith, a raw material cost, etc. For example, in view of obtaining enhanced plastic workability/formability and heat radiation performance, it is preferable to select a pure aluminum powder. As compared with aluminum alloy powders, the pure aluminum powder is advantageous in terms of a raw material cost. Preferably, the pure aluminum powder has a purity of 99.5% or more (a commercially available pure aluminum powder typically has a purity of 99.7% or more).

In case of giving neutron absorption capability to an aluminum matrix composite material, i.e., reducing neutron penetration, a boron compound is used for an after-mentioned ceramic powder. With a view to obtaining further enhanced neutron absorption capability, at least one element having neutron absorption capability, such as hafnium (Hf), samarium (Sm) or gadolinium (Gd), may be added to the aluminum powder, preferably in an amount of 0.1 to 50 mass %.

If it is necessary for an aluminum matrix composite material to have high-temperature strength, the aluminum powder may be added with at least one selected from the group consisting of titanium (Ti), vanadium (V), chromium (Cr), manganese (Mn), magnesium (Mg), iron (Fe), copper (Cu), nickel (Ni), molybdenum (Mo), niobium (Nb), zirconium (Zr) and strontium (Sr). If it is necessary for an aluminum matrix composite material to have room-temperature strength, the aluminum powder may be added with at least one selected from the group consisting of silicon (Si), iron (Fe), copper (Cu), magnesium (Mg) and zinc (Zn). In these cases, each of the above elements may be added in an amount of 7 weight % or less, and two or more of the above elements may be added in a total amount of 15 mass % or less.

While an average particle size of the aluminum powder is not limited to a specific value, an upper limit of the average particle size may be typically set at 200 μm or less, preferably 100 μm or less, and more preferably 30 μm or less. A lower limit of the average particle size may also be freely determined in consideration of manufacturability, and may be typically set at 0.5 μm or more, and preferably 10 μm or more. In particular, a particle size distribution of the aluminum powder may be set at 100 μm or less, and an average particle size of the after-mentioned ceramic powder serving as a reinforcing material may be set at 40 μm or less. In this case, the reinforcing particles are uniformly dispersed over the aluminum powder to significantly reduce a low density region of the powder mixture so as to effectively provide stable properties to the MMC plate.

An excessive difference between respective average particle sizes of the aluminum powder and the after-mentioned ceramic powder is likely to cause cracking during rolling. An excessively large average particle size of the aluminum powder causes difficulty in being uniformly mixed with the after-mentioned ceramic powder having a restriction on increasing an average particle size. Conversely, an excessively small average particle size of the aluminum powder is likely to cause aggregation of the aluminum fine particles, which leads to significant difficulty in being uniformly mixed with the after-mentioned ceramic powder. The aluminum powder having an average particle size set in the above preferable range can provide further enhanced plastic workability/formability and mechanical properties to the pre-rolling assembly.

An average particle size of the aluminum powder in the present invention is expressed by a value based on a laser-diffraction particle-size-distribution measurement method. A particle shape of the aluminum powder is not limited to a specific one. For example, the aluminum powder may have a teardrop shape, a perfect spherical shape, a spheroidal shape, a flake shape or an amorphous shape, without any problems.

A production method for the aluminum powder is not limited to a specific one. For example, the aluminum powder may be prepared by any conventional metal powder production method. For example, the conventional method may include an atomization process, a melt spinning process, a rotating disk process, a rotating electrode process, and other rapid solidification processes. In view of industrial production, it is preferable to select the atomization process, particularly a gas atomization process of atomizing molten metal to produce fine particles.

Preferably, the molten metal is subjected to the atomization process while being heated at a temperature ranging from 700 to 1200° C., because atomization of the molten metal can be effectively achieved when a temperature of the molten metal is set in the above range. An atomizing medium may be air, nitrogen, argon, helium, carbon dioxide or water, or a mixed gas thereof. In view of economic efficiency, air, nitrogen gas or argon gas is preferable as the atomizing medium.

Ceramic Powder

A ceramic material to be mixed with the aluminum powder so as to form the powder mixture includes Al₂O₃, SiC, B₄C, BN, aluminum nitride and silicon nitride. These ceramic materials may be used in powder form, independently or in the form of a mixture of two or more of them, and may be selected depending on an intended purpose of an aluminum matrix composite material. When a boron-based ceramic powder is used, an aluminum matrix composite material to be obtained can be used as a neutron-absorbing material, because boron (B) has neutron absorption capability (i.e., capability to inhibit penetration of neutrons). In this case, a boron-based ceramic material may include B₄C, TiB₂, B₂O₃, FeB and FeB₂. These boron-based ceramic materials may be used in powder form, independently or in the form of a mixture of two or more of them. In particular, it is preferable to use boron carbide (B₄C) largely containing B-10 (¹⁰B) which is the isotope of B and capable of excellently absorbing neutrons.

The ceramic powder is contained in the aforementioned aluminum powder preferably in an amount of 0.5 to 90 mass %, more preferably 5 to 60 mass %, and particularly preferably 5 to 45 mass %. The reason for the lower limit set at 0.5 mass % is that, if the content of ceramic powder becomes less than 0.5 mass %, an aluminum matrix composite material cannot be adequately reinforced. The reason for the upper limit set at 90 mass % is that, if the content of ceramic powder becomes greater than 90 mass %, an aluminum matrix composite material will have difficulty in plastic working due to increased resistance to deformation, and a compact therein will be likely to fracture due to a brittle structure. Moreover, a bonding between aluminum particles and ceramic particles will deteriorate, and thereby the compact is highly likely to have voids therein to cause difficulty in obtaining intended functions and deterioration in thermal conductivity. Further, a cutting performance of the aluminum matrix composite material will deteriorate.

The ceramic powder, such as a B₄C or Al₂O₃ powder, may have any average particle size. Preferably, the average particle size of the ceramic powder is set in the range of 1 to 30 μm. As described in connection with the average particle size of the aluminum powder, a difference between respective average particle sizes of the two powders is preferably selected by requirement. For example, the average particle size of the ceramic powder is more preferably set in the range of 5 to 20 μm. If the average particle size of the ceramic powder becomes greater than 20 μm, an aluminum matrix composite material will have a problem that saw teeth are rapidly worn during cutting. If the average particle size of the ceramic powder becomes less than 5 μm, aggregation of fine ceramic particles is highly likely to occur to cause difficulty in being uniformly mixed with the aluminum powder.

An average particle size of the ceramic powder in the present invention is expressed by a value based on a laser-diffraction particle-size-distribution measurement method. A particle shape of the ceramic powder is not limited to a specific one. For example, the ceramic powder may have a teardrop shape, a perfect spherical shape, a spheroidal shape, a flake shape or an amorphous shape.

Casing

Each of a metal casing, upper and lower casings, a casing body and a plug member (hereinafter referred to collectively as “casing”) for use in the metal matrix composite material according to this embodiment may be made of any metal capable of being adequately bonded to the powder mixture. Preferably, the casing is made of aluminum or stainless steel. For example, in the casing made of aluminum, pure aluminum (e.g., JIS 1050 or 1070) is usually used. Alternatively, various types of aluminum alloys, such as an Al—Cu based alloy (e.g., JIS 2017), an Al—Mg based alloy (e.g., JIS 5052), an Al—Mg—Si based alloy (e.g., JIS 6061), an Al—Zn—Mg based alloy (e.g., JIS 7075) and an Al—Mn based alloy, may be used for the casing.

A composition of the aluminum may be selectively determined in consideration of desired characteristics or properties, cost, etc. For example, in view of obtaining enhanced plastic workability/formability and heat radiation performance, it is preferable to select pure aluminum. As compared with aluminum alloys, pure aluminum is advantageous in terms of a raw material cost. In view of obtaining further enhanced strength and plastic workability, it is preferable to select an Al—Mg based alloy (e.g., JIS 5052). With a view to obtaining further enhanced neutron absorption capability, at least one element having neutron absorption capability, such as Hf, Sm or Gd, may be added to the aluminum, preferably in an amount of 1 to 50 mass %.

(2) Production Process

2-1: Powder-Mixture Preparation Process

An aluminum powder and a ceramic powder are prepared and uniformly mixed together. The aluminum powder may be a single type, or may be a mixture of plural types of aluminum powders. The ceramic powder may be a single type, or may be a mixture of plural types of ceramic powders, for example, a mixture of B₄C and Al₂O₃ powders. The aluminum powder and the ceramic powder may be mixed in a conventional manner using any type of mixer, such as a V blender or a cross rotary mixer or a drum blender; or a planetary mill, for a predetermined time (e.g., about 10 minutes to 10 hours). The mixing may be dry mixing or may be wet mixing. With a view to grinding during mixing, a grinding medium, such as alumina or SUS balls, may be appropriately added.

Fundamentally, the powder-mixture preparation process consists only of the step of mixing the aluminum and ceramic powders to prepare a powder mixture, and the obtained powder mixture is sent to a next step.

2-2: Casing Preparation Process

In a casing preparation process, a hollow and flat-shaped metal casing for packing the powder mixture prepared through the above powder-mixture preparation process is prepared.

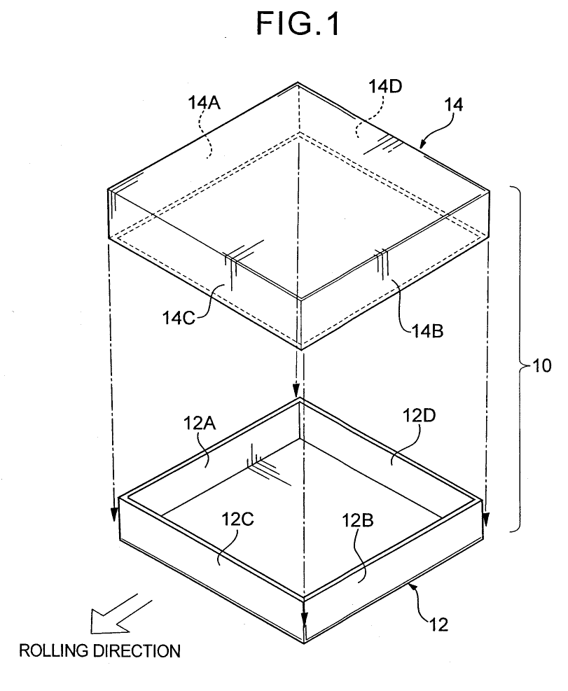

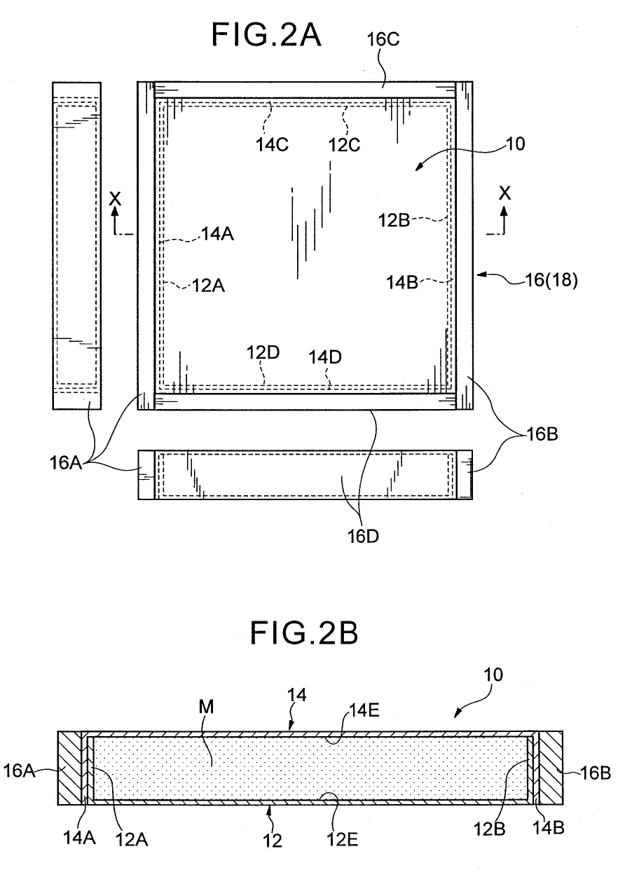

Specifically, a lower casing 12 and an upper casing 14 are prepared to form the metal casing 10. The lower casing 12 is made of aluminum, and formed in a shape which has opposed lateral walls 12A, 12B, a front wall 12C, a rear wall 12D (see FIG. 1) and a bottom wall 12E (see FIG. 2B). The upper casing 14 is made of aluminum, i.e., made of the same material as that of the lower casing 12, and formed in a shape which has opposed lateral walls 14A, 14B, a front wall 14C, a rear wall 14D (see FIG. 1) and a top wall 14E (see FIG. 2B). More specifically, the lower casing 12 is formed in a rectangular parallelepiped shape which has a closed bottom and an open top, and the upper casing 14 is formed in an approximately rectangular parallelepiped shape adapted to cover an outer peripheral surface of the lower casing 12 from above so as to serve as a closing member for closing the open top of the lower casing 12. That is, the upper casing 14 is formed to have a size slightly greater than that of the lower casing 12 to be fittable to the lower casing 12.

2-3: Reinforcing Frame Preparation Process

A reinforcing frame 16 for reinforcing an outer peripheral surface of the casing 10, specifically an outer peripheral surface of the casing 10 in a posture during rolling as shown in FIG. 2A, after an after-mentioned packing process, is prepared. The posture of the casing 10 during rolling means a state when the casing 10 is positioned in such a manner that a longitudinal axis thereof (any central axis of the casing 10 when it has a square shape in top plan view) extends along a rolling direction and a surface thereof to be rolled extends along a horizontal direction.

The reinforcing frame 16 comprises first and second reinforcing members 16A, 16B adapted to be fixed to respective ones of the opposed lateral walls 14A, 14B of the upper casing 14 each parallel to the rolling direction, in such a manner as to extend along the rolling direction, and third and fourth reinforcing members 16C, 16D adapted to be fixed to respective ones of the front wall 14C and the rear wall 14D of the upper casing 14 each perpendicular to the rolling direction, in such a manner as to extend along a direction perpendicular to the rolling direction.

Each of the first and second reinforcing members 16A, 16B is formed to have a length allowing front and rear ends thereof located along the rolling direction to extend beyond respective ones of front and rear ends of a corresponding one of the lateral walls 14A, 14B of the upper casing 14, when the first and second reinforcing members 16A, 16B are fixed to the respective lateral walls 14A, 14B. Each of the third and fourth reinforcing members 16C, 16D is formed to have a length equal to a length of a corresponding one of the front and rear walls 14C, 14D of the upper casing 14 in a direction perpendicular to the rolling direction, and is fixed or secured to the first and second reinforcing members 16A, 16B.

2-4: Packing Process

Then, the powder mixture M prepared through the aforementioned powder-mixture preparation process is packed into the lower casing 12. This packing process is performed as an operation of feeding the powder mixture M at a constant feed rate. In concurrence with the constant feeding operation, an operation of tapping the lower casing 12, i.e., an operation of mechanically compacting the powder mixture M, is performed to increase a density (packing density) of the powder mixture M. The tapping operation is performed to allow a theoretical filling rate of the powder mixture M to be in the range of 35 to 65%.

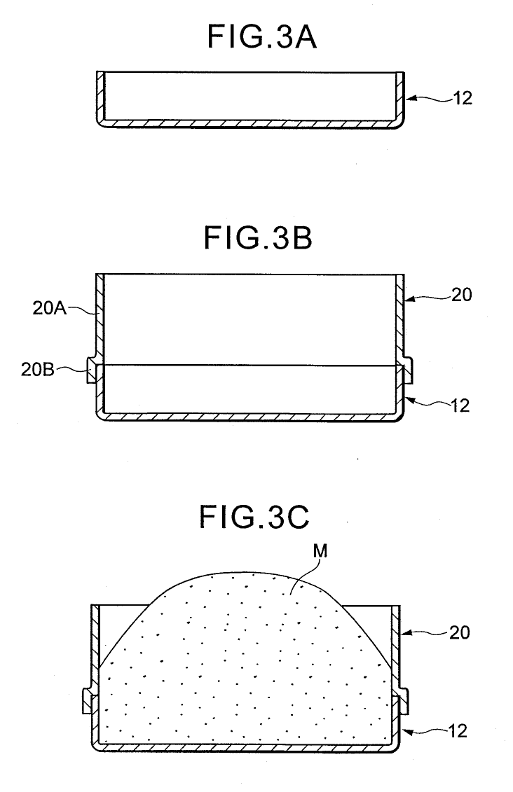

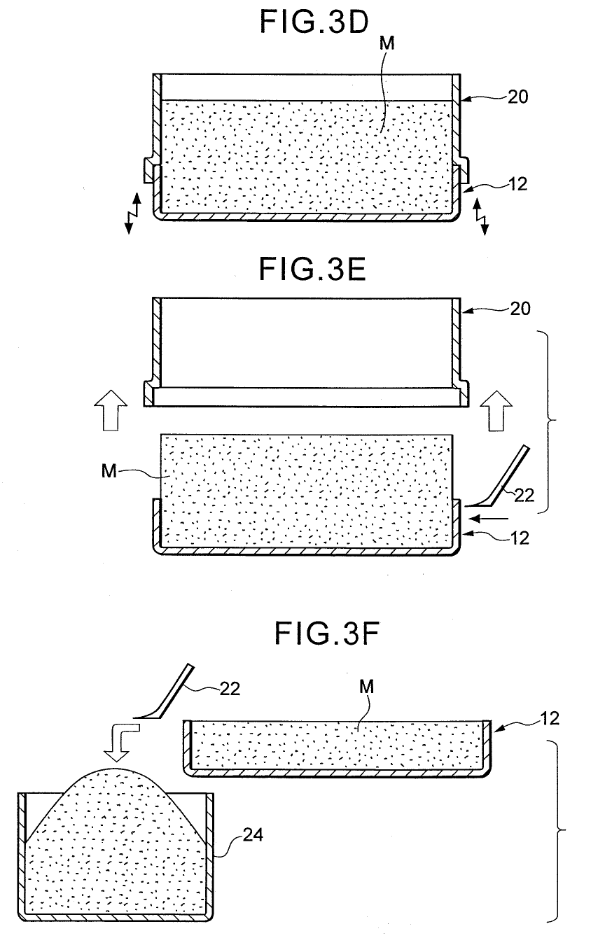

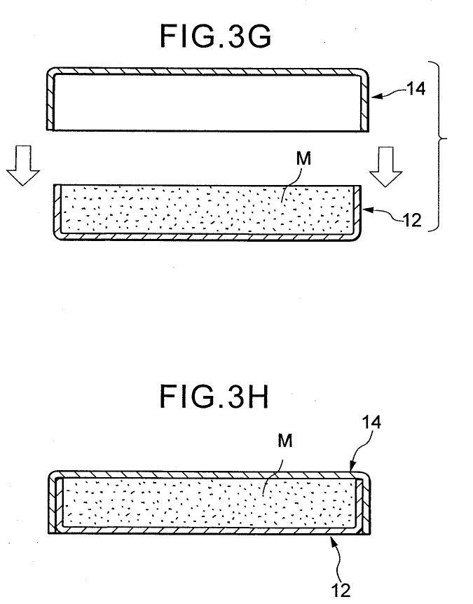

Specifically, as shown in FIG. 3A, the lower casing 12 is placed at a given packing position in a posture where an open end thereof is oriented upwardly. Then, as shown in FIG. 3B, a cylindrical-shaped extension sleeve 20 is placed on the lower casing 12. The extension sleeve 20 comprises a sleeve body 20A having a lower edge adapted to be in close contact with an entire surface of an upper edge of the lower casing 12 in a state after the extension sleeve 20 is placed on the lower casing 12, and a skirt portion 20B integrally formed with an outer peripheral surface of an lower end of the sleeve body 20A to protrude outwardly and then extend in a direction opposite to the sleeve body 20A and adapted to be fitted onto an entire outer peripheral surface of an upper end of the lower casing 12 in a state after the extension sleeve 20 is placed on the lower casing 12.

In the state after the extension sleeve 20 is placed on the lower casing 12 in the above manner, as shown in FIG. 3C, the powder mixture M is fed from an open top end of the extension sleeve 20 into an internal space defined by the lower casing 12 and the extension sleeve 20.

In the state after the powder mixture is fed into the internal space, the lower casing 12 and the extension sleeve 20 are subjected to tapping. Thus, as shown in FIG. 3D, a packing density of the powder mixture M fed in the internal space defined by the lower casing 12 and the extension sleeve 20 is increased, and a top surface of the powder mixture M will be gradually lowered along with an increase in the packing density.

Then, when the packing density of the powder mixture M is increased up to a desired value after a given tapping time-period has elapsed, the tapping operation is stopped, and the extension sleeve 20 is moved upwardly and detached from the lower casing 12. Thus, as shown in FIG. 3E, the powder mixture is left in the lower casing 12 in a densified state which allows a shape thereof to be maintained. Specifically, the powder mixture M is left in the lower casing 12 in such a manner that a portion thereof which has been located in the extension sleeve 20 protrudes upwardly from the upper edge of the lower casing 12, as shown in FIG. 3E.

Then, a scraper 22 is moved along the upper edge of the lower casing 20 to scrape away the protruded portion of the powder mixture M laterally, and the scraped powder mixture is collected to a collector box 24, as shown in FIG. 3F. The collected powder mixture will be subsequently returned to the aforementioned blender, and reused after being subjected to agitating or beating.

Through the scraping operation, the powder mixture M is fully packed into the lower casing 12 at an increased packing density. In other words, a top surface of the powder mixture M packed in the lower casing 12 becomes flush with the upper edge of the lower casing 12.

Then, the upper casing 14 is fitted onto the lower casing 12 from above to close the open top of the lower casing 12, as shown in FIG. 3G, so as to form a pre-rolling assembly 18 having the powder mixture M fully packed therein, as shown in FIG. 3H.

A configuration of the pre-rolling assembly 18 illustrated in FIG. 3H is of essential importance as a pre-rolling material (i.e., a material to be subjected to rolling in an after-mentioned rolling process) to be used for producing the metal matrix composite material of the present invention. Specifically, in a three-layer structure obtained by rolling the pre-rolling assembly 18, the bottom wall 12E of the lower casing 12, the powder mixture M, and the top wall 14E of the upper casing 14, make up a lowermost layer, an intermediate layer, and an uppermost layer, respectively, as will be described in more detail.

In order to allow the three-layer cladded structure to exert sufficient mechanical characteristics, the adjacent ones of the three layers are required to be in close contact relation with each other. In the metal matrix composite material according to this embodiment, a bottom surface of the powder mixture M is fully in close contact with an entire upper surface of the bottom wall 12E of the lower casing 12, and a top surface of the powder mixture M is fully in close contact with an entire lower surface of the top wall 14E of the upper casing 14. Thus, the adjacent ones of the three layers will be rolled in the close contact state and tightly bonded to each other to ensure sufficient mechanical characteristic of the three-layer cladded structure after rolling, as will be described.

Then, an operation of reinforcing the pre-rolling assembly 18 by the reinforcing frame 16 is performed. The reinforcing operation is performed by surrounding an outer peripheral surface, except top and bottom surfaces, of the pre-rolling assembly 18 in a posture during rolling by the reinforcing frame 16, as shown in FIG. 2B.

More specifically, each of the first and second reinforcing members 16A, 16B is temporarily fixed to a corresponding one of the lateral walls 14A, 14B of the upper casing 14, in such a manner that opposite ends (i.e., the front and rear ends) thereof located along the rolling direction extend beyond respective ones of the front and rear ends of the corresponding one of the lateral walls 14A, 14B. Then, the third reinforcing member 16C is temporarily fixed to the front wall 14C of the upper casing 14, in such a manner that the opposite lateral ends thereof come into contact with the respective front ends of the first and second reinforcing members 16A, 16B, and the fourth reinforcing member 16D is temporarily fixed to the rear wall 14D of the upper casing 14, in such a manner that opposite lateral ends thereof come into contact with the respective rear ends of the first and second reinforcing members 16A, 16B.

The pre-rolling assembly 18 having the reinforcing frame 16 temporarily fixed thereto is put in a vacuum furnace, and the vacuum furnace is depressurized to a predetermined degree of vacuum so as to subject the powder mixture M in the pre-rolling assembly 18 to degassing.

After completion of the degassing operation, the temporarily fixed reinforcing frame 16 is finally fixed by MIG (metal inert gas) welding. Through the MIG welding, an upper edge of the reinforcing frame 16 is welded to an upper edge of the upper casing 14 all around, and a lower edge of the reinforcing frame 16 is welded to a lower edge of the upper casing 14 all around. In this state, the lower edge of the upper casing 14 is located in a closely adjacent relation to a lower edge of the lower casing 12. Thus, when the lower edge of the reinforcing frame 16 is welded to the lower edge of the upper casing 14, the lower edge of the lower casing 12 is also welded to the respective lower edges of the reinforcing frame 16 and the upper casing 14, so that the casing 10 is gas-tightly sealed in its entirety.

Due to the gas-tightly sealed casing 10, if air exists (remains) within the pre-rolling assembly 18, the air is likely to cause defects. From this point of view, a gas vent hole (not shown) is formed at each of four corners of the top wall of the upper casing 14 to release air (and other gas) from the pre-rolling assembly 18 during a rolling process so as to prevent the air from remaining within the pre-rolling assembly 18. It can also be expected to allow gas getting into the pre-rolling assembly 18 during the welding to be effectively released from the gas vent holes.

2-5: Preheating Process

Before rolling, the pre-rolling assembly 18 reinforced by the reinforcing frame 16 is preheated. This preheating is performed using a heating furnace in an ambient atmosphere at a temperature of 300 to 600° C. for a holding time of 2 hours or more. A preheating atmosphere is not limited to the ambient atmosphere. The preheating is preferably performed in an inert gas atmosphere, such as an argon gas atmosphere, more preferably a vacuum atmosphere of 5 Pa or less.

2-6: Rolling Process

In a rolling process, the preheated assembly 18 is subjected to rolling as one of the plastic workings. In advance of the description on the rolling process, conditions of the pre-rolling or preheated assembly 18 for providing a unique advantage of the present invention will be described below.

The powder mixture in the pre-heated assembly 18 to be subjected to the rolling process is maintained in powder form without being solidified. That is, the powder mixture is not subjected to a preforming process for allowing a powder mixture to be maintained in a given shape, specifically a process of preforming a powder mixture in an intended shape through press working or pulse-current pressure sintering. In this production method, although the powder mixture is packed in the pre-rolling assembly at a relatively high filling rate by the aforementioned tapping operation, the tapping operation is performed to increase the filling rate to an extent allowing the powder mixture to be maintained in powder form without causing solidification thereof.

In addition, when the powder mixture M maintained in powder form is subjected to the rolling process, it is sandwiched from above and below by metal or aluminum members. Specifically, the top surface of the powder mixture M is covered by the top wall 14E of the upper casing 14 fully and tightly, and the bottom surface of the powder mixture M is covered by the bottom wall 12E of the lower casing 12 fully and tightly. In this manner, the pre-rolling assembly 18 is formed as a three-layer cladded structure having the powder mixture M packed and sealed in the casing 10 and sandwiched from above and below by the aluminum members, to makes up a pre-rolled material of a plate-shaped cladded material.

The preheated assembly 18 is subjected to rolling, and formed in an intended shape. In case of forming the preheated assembly 18 in a plate shape, a plate-shaped cladded material having a given clad rate of an Al plate and/or an Al casing can be obtained only through cold rolling. In hot plastic working, a single plastic working may be performed, or plural types of plastic workings may be performed in combination. Alternatively, after hot plastic working, cold plastic working may be performed. In case of performing cold plastic working, before the cold plastic working, the pre-rolling assembly may be subjected to annealing at a temperature of 300 to 600° C. (preferably 400 to 500° C.) to facilitate the cold plastic working.

The pre-rolling assembly 18 is cladded with the aluminum plates, and therefore a surface of the pre-rolling assembly 18 is free from ceramic particles which trigger fracture during plastic working and cause wear of a roll, die or the like. This makes it possible to provide enhanced rollability and obtain an aluminum matrix composite material excellent in strength and surface texture. In addition, an obtained hot plastic-worked product has a surface clad with metal, and the metal clad is tightly bonded to the inner powder mixture M. Thus, the hot plastic-worked product is superior in corrosion resistance, impact resistance and thermal conductivity to an aluminum matrix composite material devoid of metal cladding a surface thereof.

Before rolling, a surface of the pre-rolling assembly 18 may be effectively covered by a protective plate, such as a thin plate made of SUS or Cu. This makes it possible to prevent occurrence of longitudinal (frontward/rearward) cracking which is likely to occur during plastic working.

More specifically, in the rolling process, the preheated assembly 18 is repeatedly subjected to hot rolling in 10 to 14 roll passes at rolling reduction ranging from 10 to 70%. A rolling temperature in the hot rolling is set at approximately 500° C.

The preheated assembly 18 may be finished to have a final thickness through this hot rolling. Alternatively, after this hot rolling, the hot-rolled assembly may be further subjected to warm rolling at a temperature of 200 to 300° C. Further, the assembly subjected to the first warm rolling may be subjected to second warm rolling at a temperature of 200° C. or less.

After completion of the rolling process, the rolled assembly is subjected to a heat treatment at a temperature of 300 to 600° C. for a predetermined time, i.e., to an annealing process. After completion of the annealing process, the annealed assembly is subjected to a cooling process, and a correcting process for obtaining a desired flatness. Then, opposite lateral edges, and front and rear edges of the corrected assembly, are cut off to obtain a product (plate-shaped cladded material as the metal matrix composite material) having a desired shape.

### EXAMPLES

The metal matrix composite material according to the embodiment will be more specifically described based on specific examples. Values of properties in each sample were measured in the following manner.

(1) Composition

A composition of each material was analyzed by inductively-coupled plasma (ICP) emission spectroscopy.

(2) Average Particle Size

An average particle diameter of each powder was measured by a laser diffraction particle size measurement method, using a particle size analyzer (Trade name “Microtrack” produced by Nikkiso Co., Ltd.). The average particle diameter is indicated by volume median diameter.

(3) Rollability

The presence or absence of cracking and a surface texture in each sample subjected to rolling were evaluated. A sample having surface cracking on a plate and a sample having wrinkle-like irregularities without surface cracking was evaluated as was evaluated as “x”, and a sample having neither surface cracking nor irregularities was evaluated as “◯”.

(4) Structure Observation

A piece cut from each sample was embedded in resin, and subjected to emery grinding and buffing. Then, a metal structure of the sample piece was observed by an optical microscope.

(5) Neutron Penetration Test

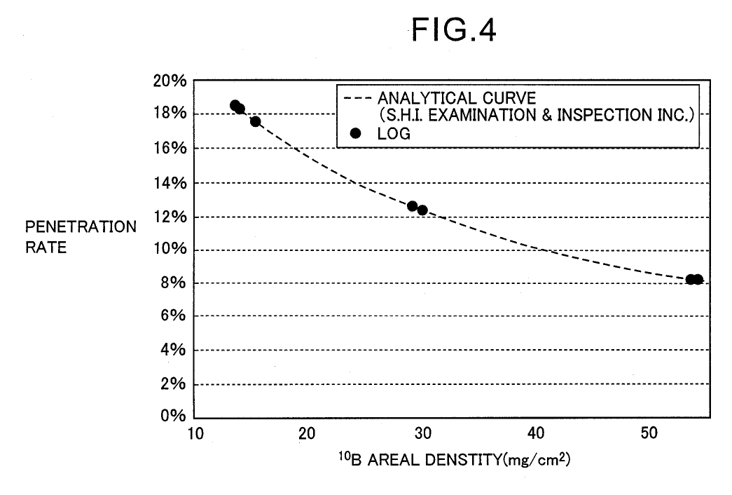

Protons accelerated by a cyclotron were brought into collision with a Be target to produce fast neutrons by a ⁹Be (p, n) ⁹B reaction. Then, the fast neutrons were made into thermal neutrons using an energy attenuation material, and the metal matrix composite material according to the embodiment was irradiated with a parallel beam of the thermal neutrons. A gold foil (diameter: 10 mm, weight: 200 mg, purity: 99.997%) was placed on each of top and bottom surfaces of the metal matrix composite material. Thus, during the irradiation, each of the gold foils was radioactivated by ¹⁹⁷Au (n, γ) ¹⁹⁸Au reaction. A neutron penetration rate was determined by a radioactivation ratio between the gold foils. FIG. 4 shows an analytical curve between a ¹⁰B areal density (mg/cm²) and the neutron penetration rate (this data was created by S.H.I. Examination & Inspection Inc., at the inventors' request).

(6) Acquisition of SEM Photographs

A SEM photographs were acquired using an SEM (Model JSM-5400 produced by JEOL Ltd.) at an acceleration voltage of 10 kV.

### Example 1

A B₄C ceramic powder was uniformly mixed with an aluminum alloy powder having a composition as shown in Table 1, in an amount of 30 mass %, to prepare a powder mixture M. The aluminum alloy powder had an average particle size (D50) of 10 μm, and the B₄C ceramic powder has an average particle size (D50) of 33 μm.

Then, a lower casing 12 made of an aluminum alloy (JIS A5052P) and formed in an approximately rectangular parallelepiped shape having outside dimensions of 367.7 mm on a side in square-shaped top and bottom surfaces, and 54.8 mm in height, and a wall thickness of 3.0 mm was prepared. Further, an upper casing 14 made of an aluminum alloy (JIS A5052P) and formed in an approximately rectangular parallelepiped shape having outside dimensions of 370.9 mm on a side in square-shaped top and bottom surfaces, and 57.8 mm in height, and a wall thickness of 3.0 mm was prepared. The aluminum alloy (JIS A5052P) had a tensile strength of 195 MPa. A composition of the aluminum alloy (JIS A5052P) is shown in the following Table 1.

TABLE 1

| | | | | | | | others | others | |
|---|---|---|---|---|---|---|---|---|---|
| Si | Fe | Cu | Mn | Mg | Cr | Zn | each | each | Al |
| 0.25% | 0.40% | 0.10% | 0.10% | 2.2% min. | 0.15% min. | 0.10% | 0.05% | 0.15% | remainder |
| or less | or less | or less | or less | 2.8% max. | 0.35% max. | or less | or less | or less | |

Two aluminum plates (made of an aluminum alloy JIS A5052P) each formed to have outside dimensions of 409.9 mm in length, 20.0 mm in width and 57.8 mm in height, a wall thickness of 3.0 mm, and an L shape in section were prepared as first and second reinforcing members 16A, 16B constituting a reinforcing frame 16. Further, two aluminum plates each formed to have outside dimensions of 370.9 mm in length, 19.5 mm in width and 57.8 mm in height, a wall thickness of 3.0 mm, and an L shape in section were prepared as third and fourth reinforcing members 16C, 16D constructing a reinforcing frame 16. The reinforcing frame 16 (i.e., first to fourth reinforcing members 16A to 16D) was made of the same material (JIS A5052P) as that of the lower and upper casing 12, 14.

The powder mixture M was put into the lower casing 12, and the lower casing 12 was tapped. The tap operation was performed under the following conditions: vibration frequency=0.53 Hz; amplitude by vibration=50 mm; input weight=15.2 to 24.1 kg; and tapping time-period=7 minutes or more.

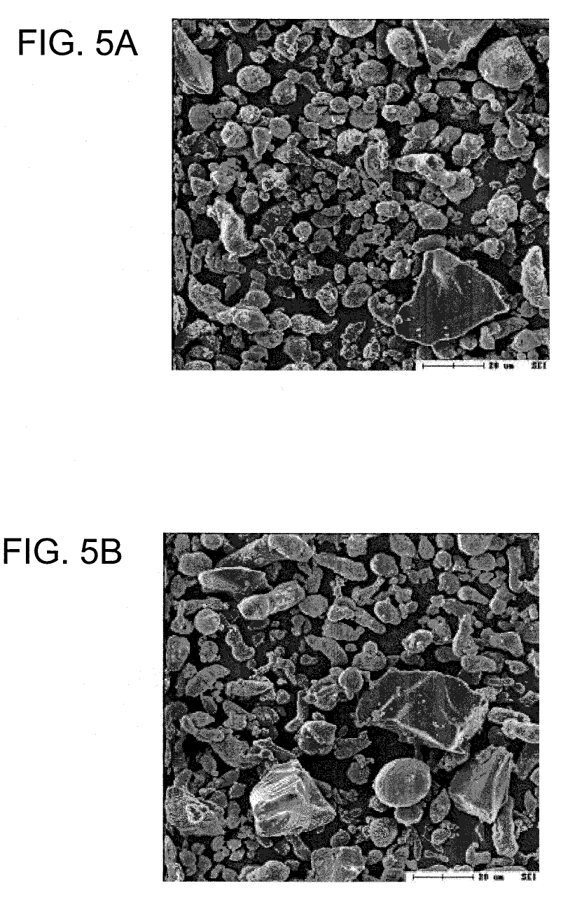

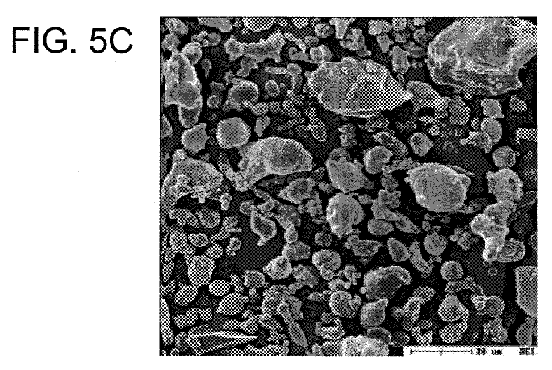

A powder density before the tapping operation was 0.77 g/cm³. FIGS. 5A to 5C are SEM photographs showing a surface of the powder mixture M before the tapping operation (the photographs were taken by 750× magnification at different positions of the same powder mixture M).

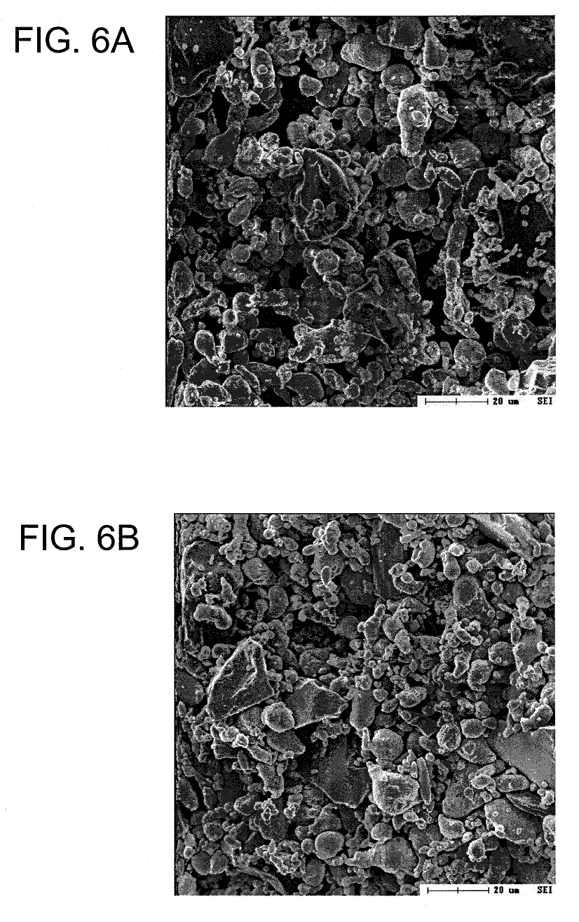

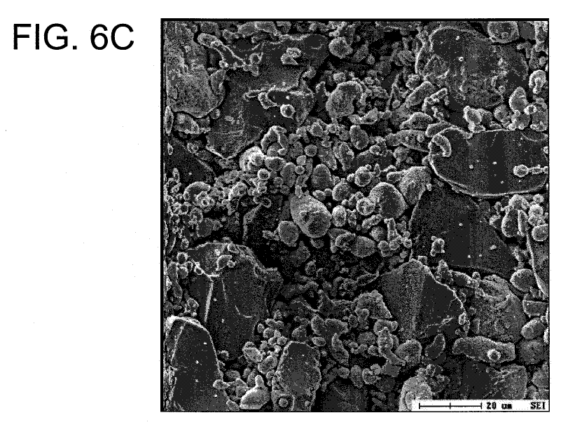

A powder density after the tapping operation was 1.36 g/cm³. FIGS. 6A to 6C are SEM photographs showing a surface of the powder mixture M after the tapping operation (the photographs were taken by 750× magnification at different positions of the same powder mixture M).

As evidenced by this result, the powder density is increased by the tapping operation to increase a packing density by about 77%.

After the tapping operation, a portion of the powder mixture M protruding upwardly from an upper edge of the lower casing 12 was scraped away in a manner as described above, and the remaining powder mixture M was fully packed in the lower casing 12. Then, the upper casing 14 was fitted on the lower casing 12 from above to form a pre-rolling assembly 18. The pre-forming assembly has a height of 57.8 mm.

Then, the obtained pre-rolling assembly 18 was preheated at 500° C. for 2 hours or more, and rolled using a two-high rolling mill (400 KW, Φ 870×900) at a rolling-initiation temperature of 500° C. and a rolling-end temperature of 100° C., in 11 roll passes, to have a final thickness of 5.7 mm. After completion of the rolling operation, the rolled assembly was subjected to annealing at a temperature of 450° C. for 4 hours, and then cooled at 200° C. Details of the 11 roll passes are shown in the following Table 2.

TABLE 2

| | Pass | | | | | | | | | | |
|---|---|---|---|---|---|---|---|---|---|---|---|
| | 1P | 2P | 3P | 4P | 5P | 6P | 7P | 8P | 9P | 10P | 11P |
| thickness | 56.0 | 49.0 | 41.0 | 35.0 | 29.0 | 22.0 | 19.0 | 11.0 | 9.0 | 7.6 | 5.7 |
| (mm) | | | | | | | | | | | |

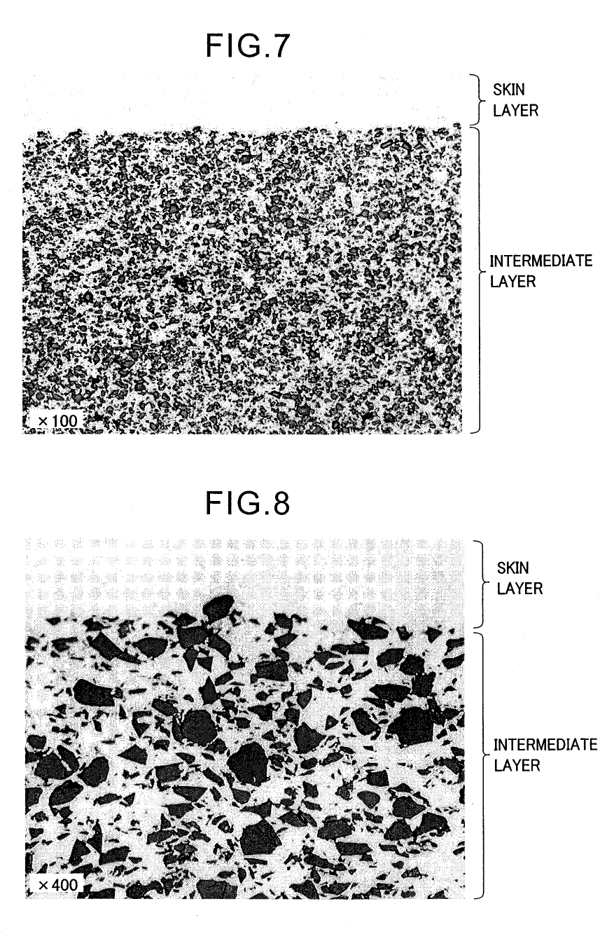

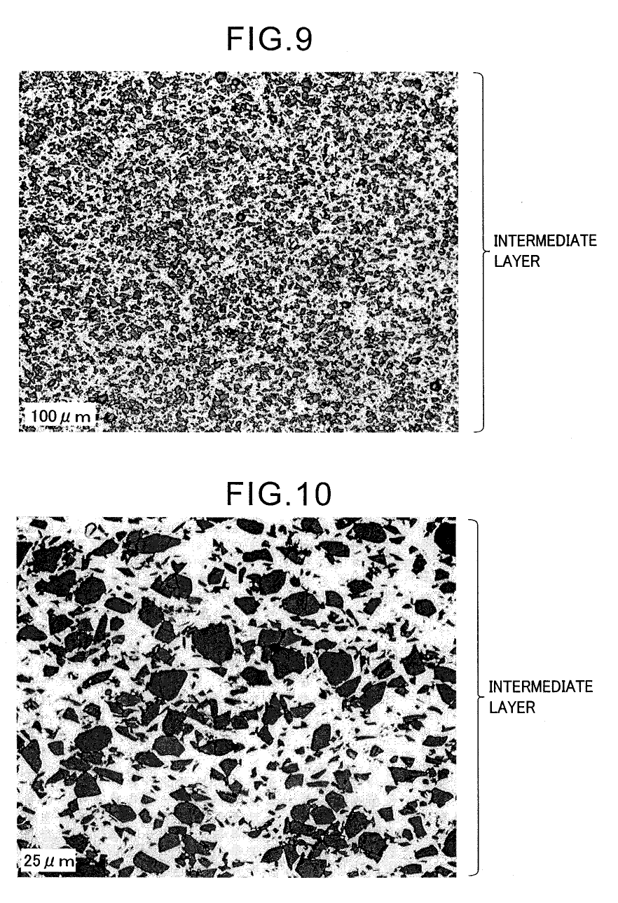

A piece was collected from a three-layer cladded material (end product) obtained in the above manner, and a metal structure of the sample piece was observed by an optical microscope. FIGS. 7 to 10 show microscopic photographs of the metal structure. FIG. 7 is a microscopic photograph (magnification: 100×) showing a region around an upper skin layer which corresponds to the top wall 14E of the upper casing 14, and FIG. 8 is a microscopic photograph (magnification: 400×) of the region around the upper skin layer in FIG. 7. FIG. 9 is a microscopic photograph (magnification: 100×) showing a region around an intermediate layer which corresponds to the rolled powder mixture M, and FIG. 10 is a microscopic photograph (magnification: 400×) of the region around the intermediate layer in FIG. 9.

As seen in the photographs of FIGS. 9 and 10, the sample is rolled to have a sufficiently high density. As seen in the photographs of FIGS. 7 and 8, the upper skin layer made up of the top wall 14E of the upper casing 14 is in tight close contact with (bonded to) the inner powder mixture M. It is understood that a lower skin layer made up of the bottom wall 12E of the lower casing 12 is tightly in close contact with (bonded to) the inner powder mixture M in the same manner as that in the upper skin layer.

A theoretical density ratio of an intermediate region (i.e., a solidified region of the powder mixture M due to the rolling) in the final product (three-layer cladded material) was calculated from a specific gravity measured by the Archimedes' method. As a result, an average of three samples was a high density of 99% which could not be achieved by conventional products, as shown in the following Table 3 (theoretical density ratio: a ratio of a computational density to a measured specific density).

TABLE 3

| Sample | A | B | C | Average |
|---|---|---|---|---|
| Theoretical density ratio | 99.0 | 99.4 | 99.5 | 99.0 |

In Table 3, the samples A, B, C were produced on different dates by the same production method as that in Example 1 (the following samples were produced in the same manner).

A typical requirement for the theoretical density ratio in trading markets of neutron absorbing materials is 97% or more. Thus, 99.0% in the above measurement result sufficiently meets the market requirement.

This high theoretical density ratio results from the capability to maximize a packing density of the powder mixture by means of tapping in the process of forming the aforementioned pre-rolling assembly. This makes it possible to increase a value of after-mentioned ¹⁰B areal density so as to achieve a desired neutron absorption rate using commercially available B₄C without using costly enriched boron.

Further, the achievement of such a high theoretical density ratio makes it possible to achieve a desired neutron absorption rate without enlarging an intermediate layer made up of the powder mixture M by reducing a clad rate, to provide high industrial applicability, in combination with the advantage of being able to eliminate the need for using enriched boron.

A clad rate of the final product was measured as 16.8%. As used herein, the term “clad rate” means a ratio of a total thickness of the upper and lower skin layers to an overall thickness of the final product (metal matrix composite material) Given that the final product has an overall thickness of 5.7 mm, and a clad rate is 16.8%, a ¹⁰B areal density is calculated as 46.9 mg/cm², according to the following general formula:

¹⁰B areal density=overall thickness (cm)×rate of B₄C-containing layer/100(%)×theoretical density of 30% B₄C-containing layer (g/cm³)×actual powder density of B₄C-containing layer/theoretical density ratio/100(%)×average content rate of B₄C/100%×content rate of B in B₄C/100(%)×content rate of ¹⁰B in B/100(%)×rate of variability/100(%)

In this formula, the “rate of B₄C-containing layer” is a rate defined by (100-clad rate). In this example, the clad rate is 16.8%, and thereby the “rate of B₄C-containing layer” is 83.2%. In this example, the rate of variability is set at 90% in prospect of variability in a purity of B₄C, the overall thickness, the clad rate, etc.

Values of this example are applied to the above general formula to calculate the ¹⁰B areal density as follows:

¹⁰B areal density=(0.57)×(83.2/100)×(2.64)×(99/100)×(30/100)×(78/100)×(18.4/100)×(90/100)=0.469 g/cm²=46.9 mg/cm²

The adequacy of 46.9 mg/cm² as the ¹⁰B areal density will be verified below.

A typical requirement for the neutron absorption rate in trading markets of neutron absorbing materials is 90% or more. This 90% neutron absorption rate is equivalent to 10% neutron penetration rate (i.e., neutron absorption rate=100−neutron penetration rate). A value of the ¹⁰B areal density capable of achieving the 10% neutron penetration rate can be derived as 40 mg/cm², based on the analytical curve in FIG. 4. That is, as the ¹⁰B areal density, the measurement result: 47.9 mg/cm², is fairly greater than 40 mg/cm² which is required for achieving the 90% neutron absorption rate as the market requirement. Thus, it is proven that 47.9 mg/cm² is adequate as a ¹⁰B areal density value sufficiently meeting the market requirement.

An optimal range of the clad rate will be verified.

As mentioned above, the clad rate is a critical factor of achievement of the neural absorption rate as a market requirement, in connection with the ¹⁰B areal density value.

Thus, under the condition that the overall thickness is maintained at 5.7 mm as in the above example, respective thicknesses of the bottom wall 12E of the lower casing 12 and the top wall 14E of the upper casing 14 were appropriately selected to set a total of nine clad rates as shown in the following Table 4 to produce nine types of final products (samples) as neutron absorbing materials.

TABLE 4

| | | | | | Evaluation | | |
|---|---|---|---|---|---|---|---|
| | | | | Neutron absorption rate | (threshold: | | |
| | | ¹⁰B Areal | | (%) | Neutron | Evaluation | |
| Sample | Clad Rate | density | Neutron | (100 − Neutron | absorption rate | (occurrence of | Comprehensive |
| No. | (%) | (mg/cm²) | Penetration Rate | Penetration Rate) | ≧90%) | cracking) | Evaluation |
| 1 | 5 | 54.8 | 8.5 | 91.5 | ∘ | x | x |
| 2 | 10 | 51.9 | 8.7 | 91.3 | ∘ | x | x |
| 3 | 13 | 50.2 | 8.9 | 91.1 | ∘ | x | x |
| 4 | 15 | 49.1 | 9.0 | 91 | ∘ | ∘ | ∘ |
| 5 | 17 | 47.9 | 9.2 | 90.8 | ∘ | ∘ | ∘ |
| 6 | 20 | 46.2 | 9.5 | 90.5 | ∘ | ∘ | ∘ |
| 7 | 25 | 43.3 | 9.9 | 90.1 | ∘ | ∘ | ∘ |
| 8 | 30 | 40.5 | 10.1 | 89.9 | x | ∘ | x |
| 9 | 35 | 37.5 | 10.6 | 89.4 | x | ∘ | x |

Then, a ¹⁰B areal density was calculated for each of the clad rates according to the above general formula, and a neutron penetration rate corresponding to the calculated ¹⁰B areal density was derived from the analytical curve in FIG. 4. Further, a neutron absorption rate is calculated from the neutron penetration rate. The nine samples were evaluated using a threshold that the neutron absorption rate is 90% or more, as a criterion. As a result, it was proven that any sample having a clad rate of greater 30% does meet the criteria.

Further, in a process of producing the final products, rollability was visually checked. As a result, it was proven that a defect, such as cracking, occurs in any final product having a thin skin layer with a clad rate of 13 or less. Thus, it was proven that any sample having a clad rate of 13 or less is defective in terms of rollability.

Considering the above two evaluation results, it was proven that the clad rate has an optimal range of 15 to 25%.

Further, thermal conductivity, and mechanical characteristics, specifically, tensile strength (σ_{B}), 0.2% proof stress (σ_{0.2}) and elongation (δ), of the final product, were measured using a conventional mechanical characteristic tester. This measurement test on each of the characteristics was carried out for three samples, and an average of measurement values of the samples was calculated to obtain a result as shown in Table 5.

TABLE 5

| | Tensile | 0.2% proof | | Thermal |
|---|---|---|---|---|
| | Strength σ_{B} | stress σ_{0.2} | Elongation | Conductivity |
| Sample | (MPa) | (MPa) | (%) | (W/m · k) |
| A | 168 | 151 | 4.0 | 104 |
| B | 170 | 152 | 4.0 | 105 |
| C | 166 | 149 | 3.8 | 101 |
| Average | 168 | 151 | 3.9 | 103 |

A typical requirement for the tensile strength (σ_{B}) in trading markets of neutron absorbing materials is 35 MPa or more. As seen in Table 5, it was verified that the final products exhibit sufficient tensile strength (σ_{B}), specifically, a high average of 168 MPa which is slightly less that about 5 times of the market requirement.

In order to check a correlative relationship between respective ones of a ¹⁰B areal density, a tensile strength and a neutron absorption rate in the neutron absorbing material in this example, the tensile strength and the neutron absorption rate were measured while changing the ¹⁰B areal density.

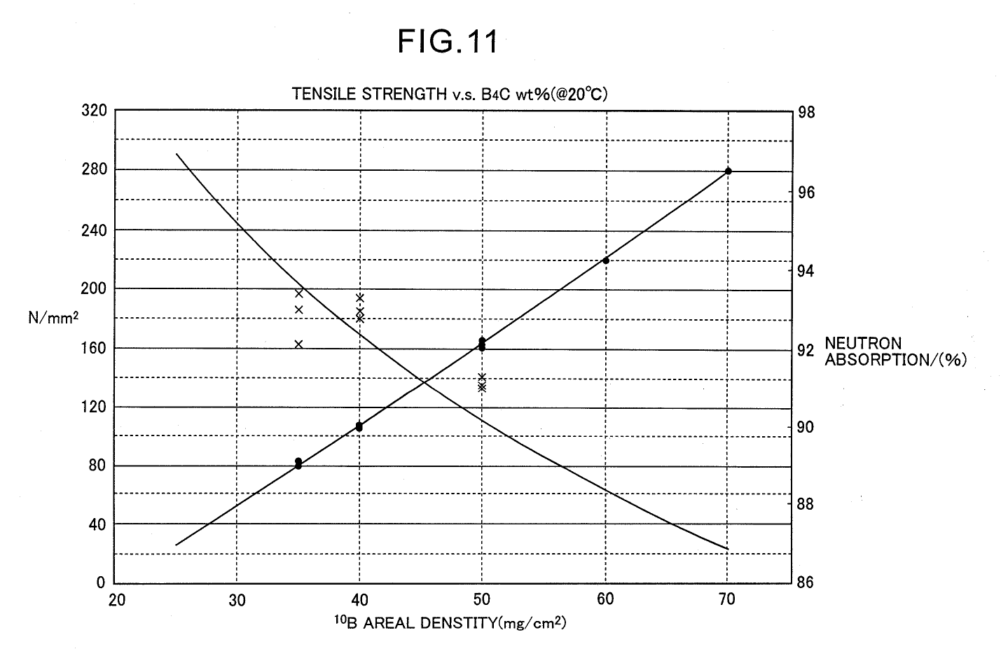

A result of this measurement is shown in FIG. 11.

As seen in FIG. 11, the neutron absorption rate becomes greater than 90% only if the ¹⁰B areal density is 40 mg/cm² or more. Further, if the ¹⁰B areal density is 40 mg/cm² or more, the tensile strength is essentially required to be 110 MPa or more. If the ¹⁰B areal density is in the range of 40 to 50 mg/cm², both the requirements of the neutron absorption rate and the tensile strength are satisfied.

That is, in the neutral absorbing material as the metal matrix composite material according to the above embodiment, if the ¹⁰B areal density is in the range of 40 to 50 mg/cm², the neutron absorption rate can be maintained at 90% or more, and the tensile strength can be maintained at 110 MPa or more. Thus, the neutral absorbing material has a capability to reliably meet the market requirements and exhibit performance values greater than the market requirements.

A typical requirement for the 0.2% proof stress (σ₀₋₂) in trading markets of neutron absorbing materials is 50 MPa or more. It was verified that the final products exhibit sufficient 0.2% proof stress (σ_{0.2}), specifically a significant high average of 151 MPa which is about 3 times of the market requirement.

A typical requirement for the elongation (δ) in trading markets of neutron absorbing materials is 0.5% or more. It was verified that the final products exhibit sufficient elongation (δ), specifically a high average of 3.9% which is slightly less than about 8 times of the market requirement.

As above, the neutron absorbing material as the metal matrix composite material according to the above embodiment exhibited performance values fairly greater than the market requirements for mechanical characteristics, and had sufficient mechanical strength. Thus, it was verified that the neutron absorbing material has high industrial applicability.

A typical requirement for the thermal conductivity in trading markets of neutron absorbing materials is 60 W/m·K or more. It was verified that the final products exhibit sufficient thermal conductivity, specifically, a high average of 103 W/m·K which is about 1.5 times of the market requirement.

As above, the neutron absorbing material as the metal matrix composite material according to the above embodiment exhibited performance values fairly greater than the market requirements for thermal conductivity, and had sufficient thermal conductivity. Thus, it was verified that the neutron absorbing material has high industrial applicability.

While the first embodiment has been described based on one example where a matrix material of the powder mixture M comprises a B₄C ceramic powder and an aluminum powder, the matrix material for use in the metal matrix composite material of the present invention is not limited to such a composition. It is also understood that a primary component of the matrix material is not limited to aluminum, but may be a powder of any other suitable metal element, such as copper, magnesium, titanium, gallium, iron or indium.

Advantageous embodiments of the invention have been shown and described. It is obvious to those skilled in the art that various changes and modifications may be made therein without departing from the spirit and scope thereof as set forth in appended claims.

What is claimed is:

1. A metal matrix composite material comprising:
a pair of metal plates having a powder mixture disposed therebetween forming an intermediate layer, and
the powder mixture including a metal powder and a ceramic powder, the ceramic powder having a neutron absorbing function and includes a B₄C powder, wherein the intermediate layer has a theoretical density ratio at least 98%, and a percentage of a total thickness of the metal plates to an overall thickness of the intermediate layer is in a range of 15 to 25% and the ceramic powder has a neutron absorption rate of at least 90%.

2. The metal matrix composite material as defined in claim 1, wherein:
each of the metal plates is made of an aluminum alloy or stainless steel; and
the metal powder is a powder containing aluminum.

3. The metal matrix composite material as defined in claim 1, which has a tensile strength of at least 110 MPa, and wherein the ¹⁰B areal density is 50 mg/cm² or less.

4. The metal matrix composite material as defined in claim 1, wherein the ¹⁰B areal density is at least 40 mg/cm²

5. A metal matrix composite material comprising:
a first skin layer made of a metal material; and
a second skin layer made of a metal material,
an intermediate layer disposed between and in contact with the first skin layer and the second skin layer, the intermediate layer including a metal powder and a ceramic powder, the ceramic powder having a neutron absorbing function;
wherein the intermediate layer includes a B₄C powder and the ceramic powder has a neutron absorption rate of at least 90%, wherein the intermediate layer has a theoretical density ratio at least 98%, and a percentage of a total thickness of the first and second skin layers to an overall thickness of the intermediate layer is in a range of 15 to 25%.

6. The metal matrix composite material as defined in claim 5, wherein:
each of the first and second skin layers includes an aluminum alloy or stainless steel; and
the metal powder is a powder containing aluminum.

7. The metal matrix composite material as defined in claim 5, which has a tensile strength of at least 110 MPa, and wherein the ¹⁰B areal density is 50 mg/cm² or less

8. The metal matrix composite material as defined in claim 5, wherein the ¹⁰B areal density is at least 40 mg/cm²

9. A metal matrix composite material made by a process, the metal matrix composite material comprising:
a pair of metal plates having a powder mixture disposed therebetween forming an intermediate layer, and the powder mixture including a metal powder and a ceramic powder, the ceramic powder having a neutron absorbing function and includes a B₄C powder, wherein the intermediate layer has a theoretical density ratio at least 98%, and a percentage of a total thickness of the metal plates to an overall thickness of the intermediate layer is in a range of 15 to 25% and the ceramic powder has a neutron absorption rate of at least 90%, the metal matrix composite material being produced by the process comprising the steps of:
(a) mixing the metal powder and the ceramic powder to prepare the powder mixture;
(b) providing a metal casing having the first metal plate and the second metal plate;
(c) packing the powder mixture into at least one of the metal plates;
(d) combining the metal plates to form the metal casing filled with the powder mixture by placing the upper casing on the lower casing so as to prepare a pre-rolling assembly;
(e) preheating the pre-rolling assembly in such a manner so as to maintain the powder mixture in a powder state; and
(f) rolling the pre-rolling assembly following said step of preheating to obtain the metal matrix composite material.

10. A metal matrix composite material made by the process as defined in claim 9, wherein said step of packing includes increasing a packing density of the powder mixture by tapping.

11. A metal matrix composite material made by a process as defined in claim 9, wherein said step of packing includes packing the powder mixture to allow a top surface of the powder mixture to become flush with an upper surface of the metal casing.
